(19) United States
(12) Patent Application Publication
(10) Pub. No.: US 2006/0053637 A1
(43) Pub. Date: Mar. 16, 2006

(54) Package opening device

(76) Inventor: Gabe Neiser, Port Jefferson Station, NY (US)

Correspondence Address: KEUSEY, TUTUNJIAN & BITETTO, P.C., 20 CROSSWAYS PARK NORTH, SUITE 210, WOOBURY, NY, 11797, US

(21) Appl. No.: 10/941,148

(22) Filed: Sep. 15, 2004

(51) Int. Cl. B26B 29/00

(52) U.S. Cl. 30/286

(57) ABSTRACT

A package opening device having a movable member hingedly connected to a base. At such point of connection, the movable member separates a cutting area from a grip area on the base. A cutting element is provided on a top face of the cutting area of the base and is preferably comprised of a ceramic material for facilitating cutting of e.g., shrink-wrapped packaging. The movable member is pivotable with respect to the base, wherein in an open position the movable member is pivoted to expose the cutting area, and thus the cutting element. In a closed position, the movable member may be folded flat against the base to cover the cutting element, the movable member including a relief to accomodate the cutting element when closed. The grip area is provided to facilitate handling of the package opening device during use.

### BACKGROUND OF THE INVENTION

1. Technical Field

The present invention relates generally to package openers, and more specifically, to a package opening device for opening shrink-wrapped packaging such as jewel packages containing compact discs and DVDs.

2. Description of Related Art

It is widespread commercial practice to produce and sell Compact Discs (CD's), digital video discs (DVD's), cassette tapes and the like in shrink-wrapped plastic cases (e.g., “jewel boxes”). Such packages typically include a thin but tough layer of plastic film or sheet material completely enclosing a jewel box, plastic casing and/or cardboard packaging, and is typically notoriously difficult to remove.

Although opening tabs and/or tear strips may be provided on such shrink wrapping, these are often also extremely difficult to manipulate and remove. As a result, in efforts to remove such packaging, customers often resort to using sharp objects and tools such as scissors, knives, blades etc. which risks injury to themselves and/or may even damage the product itself.

Accordingly, an efficient, effective and safe device adapted for opening shrink-wrapped packaging, especially for Compact Discs and the like, is highly desirable.

### SUMMARY OF THE INVENTION

The present invention is directed to a specially constructed, safe and effective cutting device for use in opening packages, especially CD, DVD and cassette packages, which are encased within a thin, plastic film or sheet.

Advantageously, a system according to the present invention provides improved convenience and safety in opening packages, in particular shrink-wrapped packaging such as that for Compact Discs, DVD's, and the like.

According to an aspect of the present invention, a package opening device is provided comprising a base having a cutting area and a grip area and a cutting element disposed in said cutting area. A movable member is pivotably connected to said base and has open and closed positions.

In another aspect of the present invention, a package opening device is provided comprising a base having a first end, a second end and a cutting element affixed onto a top surface of the base at the first end. A movable member is pivotably attached to the top surface of the base plate between the first and second end. The movable plate is pivotable with respect to said base plate to expose said cutting element in an open position and to cover said cutting element in a closed position.

These and other aspects, features and advantages of the present invention will be described or become apparent from the following detailed description of the preferred embodiments, which is to be read in connection with the accompanying drawings.

### BRIEF DESCRIPTION OF THE DRAWINGS

In the drawings where like reference numerals depict similar elements throughout the views:

FIG. 1 is an exemplary front perspective view of a package opener in an open position according to an embodiment of the present invention.

FIG. 2A is a perspective view of the package opener of FIG. 1 showing an exemplary position in which a package is placed in the package opener;

FIG. 2B is a perspective view of the package opener of FIG. 1 showing an exemplary alternate position in which a package is placed in the package opener;

FIG. 3 is a front view of the movable plate 101;

FIG. 4 is a cross-sectional side view taken along lines A-A of FIG. 3;

FIG. 5 is a top view of the base plate 103;

FIG. 6 is a cross-sectional view taken along the lines B-B of FIG. 5;

FIG. 7 is an exemplary perspective view of a package opener in a closed position according to an aspect of the present invention;

FIG. 8 is a side view of a package opener in a closed position according to an aspect of the present invention;

FIG. 9a is a plan view of the side of the ceramic cutting element according to an embodiment of the invention; and

FIG. 9b is a front view of the ceramic cutting element according to an embodiment of the invention.

### DETAILED DESCRIPTION OF PREFERRED EMBODIMENTS

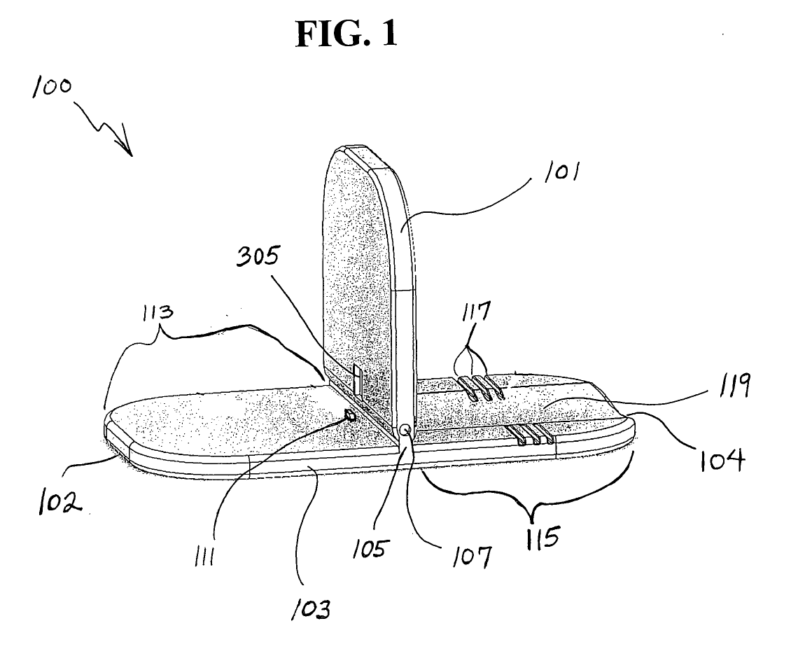

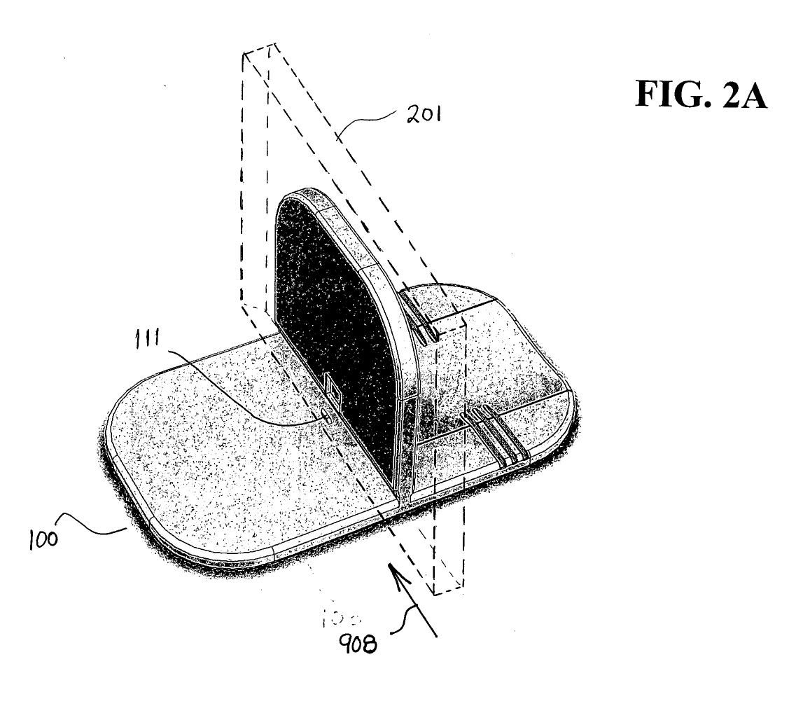

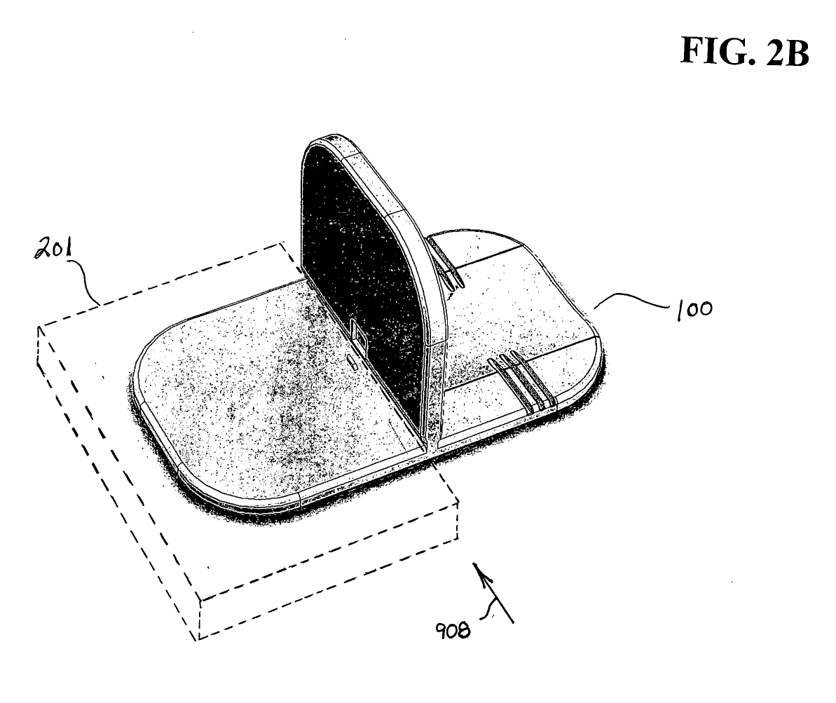

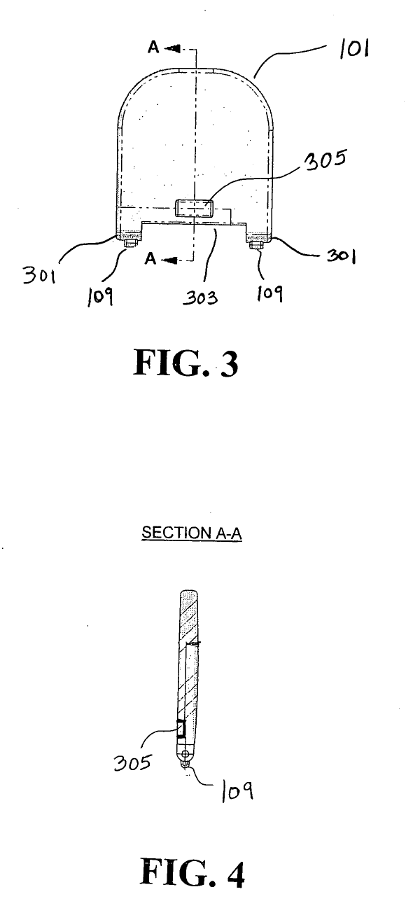

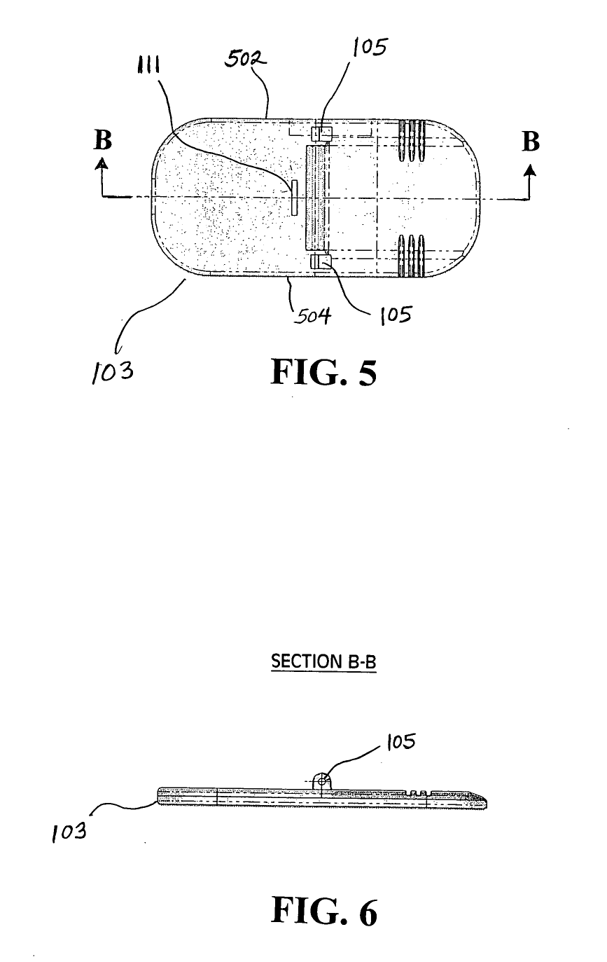

Referring now to the Figures, the illustration of FIG. 1 depicts a perspective view of a package opener 100 in an open position according to an aspect of the present invention. FIGS. 2A and 2B are perspective views of the package opener of FIG. 1 showing exemplary positions in which a package 201 is placed for opening. FIGS. 3-4 depict views of the movable member or plate 101 and FIGS. 5-6 depict exemplary views of the base member or plate 103.

The package opener 100 includes a movable plate 101 hingedly attached to a base plate 103. The movable plate 101 is attached to the base plate 103 between a cutting area 113 and a grip area 115 via hinged connections. Such hinged attachment permits the movable plate 101 to be pivotable (i.e., foldable) with respect to the base plate 103.

Both base 103 and movable member 101 may be made of any substantially rigid material (e.g., plastic, wood, rubber, metal, etc). The base plate 103 includes at least one first hinge connection 105 disposed along a top face of the base plate 103 between first end portion 102 and second end portion 104, each hinge connection preferably having a hole 107. More specifically, the first hinge connections 105 are disposed between a cutting area 113 and a grip area 115. As shown in, e.g., FIG. 1, in an exemplary embodiment, the first hinge connections 105 are located somewhat equidistant between the first and second end portions 102 and 104, respectively.

It is to be noted that the particular positions/configurations of the first hinge connections 105 as shown in the Figures are for exemplary purposes only and other positions and/or configurations of the first hinge connections 105 along the base plate 103 may be contemplated. In addition, a single hinge connection may be provided to effectuate a hinged connection between the plates 101 and 103.

In one embodiment, each end 301 (see FIG. 3) of a proximal portion 303 of the movable plate 101 includes at least one second hinge connection 109 each having, e.g., a protrusion frictionally receivable in each of the holes 107 for providing pivotable coupling between plates 101 and 103, via attachment of the first and second hinge connections 105 and 109, respectively. In an exemplary embodiment, pivotable coupling between plates 101 and 103 is achieved via a friction fit designed for pin rotation between the first and second hinge connections.

It is to be noted that the positions of the first and second hinge connections may be reversed (i.e., the base plate may include hinge connections having protrusions and the movable plate may include hinge connections having holes, wherein the protrusions are pivotably receivable in the holes, without departing from the spirit of the invention).

It is further to be noted that other means as known in the art for providing pivotable/rotatable coupling between plates 101 and 103 may be contemplated, e.g., a single hinge design, a hinge comprising a rod having ends insertable within end holes, use of bolts, a living hinge, etc.

The base plate 103 includes a cutting element 111 affixed to and protruding from its top face between end portions 102 and 104, preferably on a top face of cutting area 113 near the point of the base plate's perpendicular coupling with movable plate 101. The cutting area is defined as the area encompassing the base plate 103 from end 102 to at least the cutting element 111.

The cutting element 111 is preferably comprised of a non-metallic, ceramic-like material for facilitating cutting of shrink wrapped packaging (e.g., plastic films, cellophane, and the like) while simultaneously eliminating the risk of cutting skin or flesh, thereby preventing injury to users.

In one embodiment, such cutting element 111 comprises a ceramic material. It is to be noted that other non-metallic materials and/or shapes may be contemplated. In a preferred embodiment, the cutting element 111 is disposed substantially equidistant between sides 502 and 504 (see FIG. 5), although other locations of the cutting element 111 may be contemplated. It is further to be noted that more than one cutting element 111 may be provided in the cutting area 113 at various other locations thereon for increased/varied/desired cutting effects.

The base plate 103 further includes a grip area 115 for facilitating safe grasping of the opener 100. The grip area 115 is defined as the area of the base plate 103 from end 104 to at least grip ridges 117. While in an open position, the movable plate 101 preferably is fixed in a position substantially perpendicular to the base plate 103 in the manner as shown in FIGS. 1 and 2; i.e., the base plate 103 is disposed on a first plane and the movable plate 101 is on a second plane which intersects the base plate 103 preferably between cutting area 113 and grip area 115.

It is noted that the opener 100 may include fastening or “locking” mechanisms to releasably secure the movable plate 101 into the open position during operation (i.e., at a 90 degree angle to the base plate 103). Such fastening mechanisms may comprise, for example, compressive/friction means, detents, spring clips, retractable clamps, spring-loaded pegs, etc.

In the open position, the opener 100 provides the cutting element 111 exposed and ready for use while simultaneously shielding the cutting element 111 from the user's gripping hand during handling. Advantageously, the movable plate 101 provides an effective barrier which separates and shields the grip area 115 entirely from the cutting area 113 during use. Furthermore, as an added safety feature, the cutting element 111 itself is of a material which, while being an effective cutting tool for its intended purpose, is unlikely to cause injury to the user.

It is to be noted that the grip area may include ridges 117 and/or a concave depression 119 and/or various other ergonomic features/designs to, e.g., improve a user's secure grip of the opener 100.

The movable plate 101 includes a relief 305 therein (see FIG. 3) located at the proximal portion 303 and facing the cutting area 113. The relief 305 is preferably of a size, shape, depth and at a location suitable for at least receiving/enveloping/accomodating the protruding cutting element 111 when the movable plate 101 is in the closed position (i.e., when the movable plate 101 is folded flat against the top face of cutting area 113). In the exemplary embodiment of FIGS. 1 and 2 for example, the relief 305 comprises a rectangular indentation at the base of the movable plate 101 having interior dimensions sufficient to receive the cutting element 111 so that the cutting element 111 does not interfere with or impede the closing of the movable plate 101.

The relief 305 may be of any shape, size or dimension to at least accept the shape/dimension of the cutting element 111 to be received therein. Further, it is to be noted that the relief may be disposed at any part of the movable plate 101 depending on the location of the cutting element 111 and its particular position shown in FIGS. 1-2 is for exemplary purposes only.

Multiple cavities 305 may be provided in appropriate positions as warranted to accommodate, e.g., multiple cutting elements 111 in the cutting area 113 if necessary.

FIG. 2A shows a package 201 being positioned for opening by the package opener 100, i.e., in this embodiment, a face of the package 201 is situated parallel and adjacent to the movable plate 101 as shown. In FIG. 2B the package 201 is instead situated parallel and adjacent to a top face of the cutting area 113. In an open position, the movable plate 101 may be arranged/pivoted at any desired angle relative to the base plate 103. The movable plate 101 may be arranged in such desired open position to help provide support for the package being cut, i.e., the package may be pushed up against the movable plate 101 during cutting and even to facilitate cutting. Accordingly, the present invention advantageously provides multiple positions in which packages to be opened may be placed to achieve e.g., cuts in various areas of the package as desired.

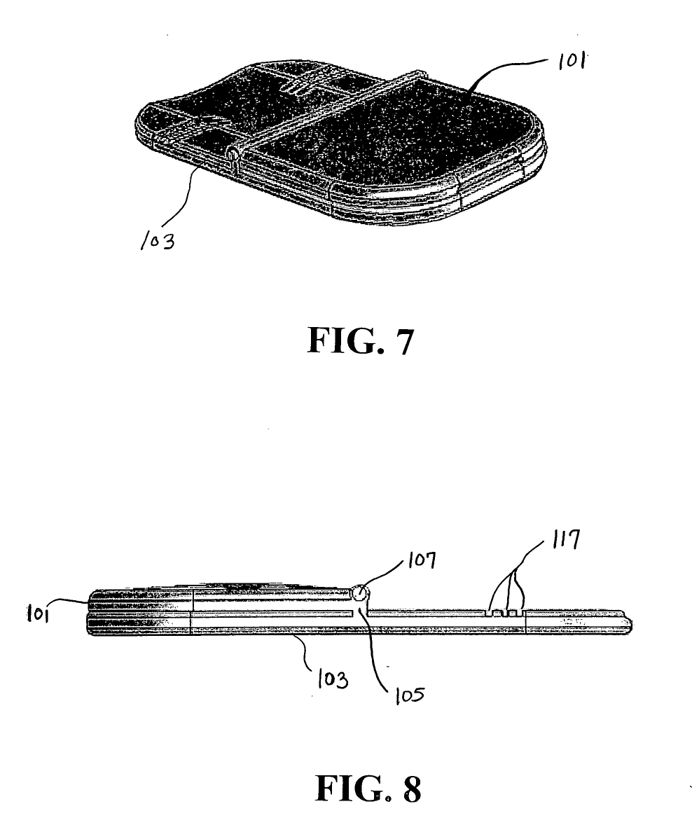

FIG. 7 is an exemplary perspective illustration of the opener 100 in a closed position according to an embodiment of the present invention. FIG. 8 is a side view of the opener 100 in a closed position. Movable plate 101 is pivotable along its hinge connection with respect to the base plate 101 and is preferably foldable flat against the top surface of the cutting area 113 when in a closed position (i.e., when the cutting element 111 is not in use). In the closed position, the cutting element 111 is completely covered, thus eliminating any chance of contact with the cutting element 111 and accordingly, eliminating risk of accidental injury.

Various securing mechanisms may be employed such as snap-fit locks, pressure snaps, etc. to secure the movable plate 101 in the closed position to prevent unintentional opening of same. Although the movable plate 101 may be manually opened from the closed position folded flat against base plate 103, in one embodiment a release mechanism may also be provided such as, for example, a button that when pressed, automatically detaches the movable plate 101 from the base plate 103 such that the movable plate 101 is automatically pivoted into the open position. Such a release mechanism and/or securing mechanisms may be located at any position on the base plate 103 or movable plate 101.

In one embodiment, the release mechanism, when activated, releases any fastening mechanism employed and automatically and forcibly pushes the movable plate 101 into an open position. Such forcible release may be enabled by, for example, a lever, rod, and/or a spring system or other implement integrated with first and/or second hinge portions 105 and 109 which is caused to apply force to any part of the movable plate 101.

Although a perpendicular arrangement of the movable plate and base plate as shown in FIG. 1 is the preferred open position, it is to be noted that the movable plate 101 of the present invention may be adapted for pivoting from 0 to 180 degrees relative to the cutting area of the base plate in an open position.

A stop mechanism may also be provided in the opener 100 (e.g., at any position on the base 103 or movable member 101) for holding the movable plate 101 stationary at any desired open position from between 0 to 180 degrees relative to the base plate 103. Examples of stop mechanisms include mechanisms that hold and release the movable plate 101 through force applied to the plate 101 itself or through other devices such as a release button attached to a mechanism internal to the opener 100 to hold plate 101 at a desired angle. Manipulation of such release button preferably activates and releases the stop mechanism.

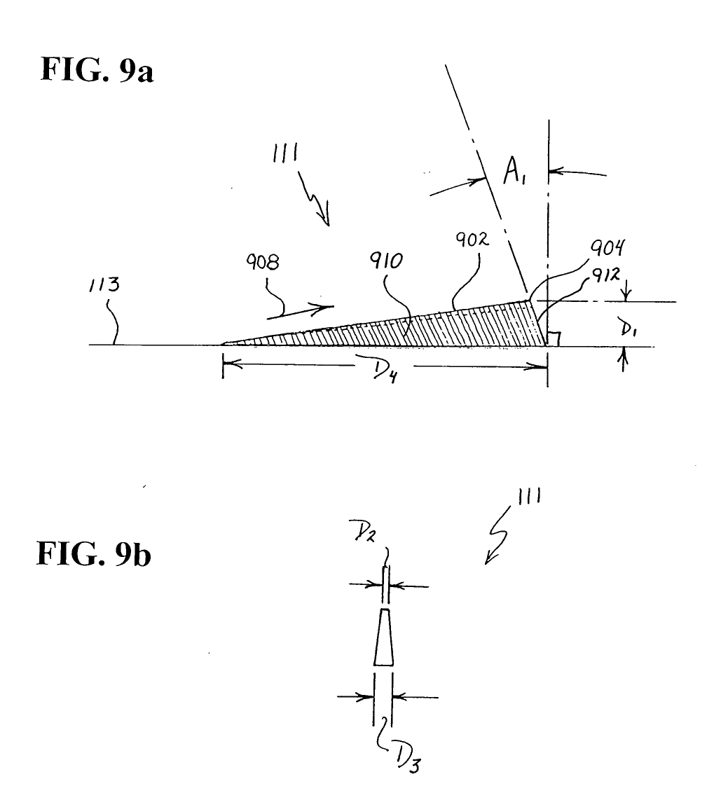

FIGS. 9a and 9b show exemplary features of the cutting element 111 according to an aspect of the invention. As shown, the ceramic cutting element 111 is trapezoidal in cross section (FIG. 9b) and includes angled upper surface 902 that extends above the cutting area surface 113. As shown, the cutting element includes an inclined surface 902 and is arranged such that its side 910 is parallel with the pivotable support 101 (see FIGS. 1-3). Inclined surface 902 ends at the cutting tip point 904 where the ceramic cutter slopes down back to cutting area surface 113.

During cutting action, the package 201 is pushed in direction 908 (FIGS. 2, 3, and 9a) over the cutting surface 902 and finally cutting tip 904. Once the package has passed over cutting tip 904, the plastic wrapping of the package 201 is scored open and easily removed. Ceramic cutting element 111 is designed such that it does not cut when used in a direction contrary to the preferred direction 908 shown. In addition, as mentioned previously, the ceramic material of cutting element 111 will not cut the user's skin (e.g., finger).

FIGS. 9a and 9b show the various dimensions of cutting element 111 which are shown here for exemplary purposes. As shown, the front surface 912 slopes down from cutting tip 904 at an angle A1 which can be, for example, 15-25 degrees. The height D1 of cutting element 111 from the cutting area surface 113 is in a range of 0.01-0.02 inches. The length D4 of the cutting element 111 can be in a range of 0.1-0.12 inches. The width D2 of upper surface 902 is small and in the range of 0.002-0.007 inches, while the width D3 of the bottom of cutting element is in a range of 0.010-0.015 inches.

Those of ordinary skill in the art will recognize that the dimensions disclosed herein are for exemplary purposes and may be changed without departing from the spirit of the invention.

Although illustrative embodiments of the present invention have been described herein with reference to the accompanying drawings, it is to be understood that the invention is not limited to those precise embodiments, and that various other alterations, modifications and improvements may be affected therein by one skilled in the art. Such alterations, modifications and improvements are intended to be within the scope and spirit of the present invention. Accordingly, the foregoing description is by way of example only and is not intended to be limiting. This invention should be limited only by the claims and equivalents thereof.

What is claimed is:

1. A package opening device comprising:
a base having a cutting area and a grip area;
a cutting element disposed in said cutting area; and
a movable member pivotably connected to said base and having open and closed positions.

2. The device of claim 1, wherein the cutting element comprises a non-metallic material.

3. The device of claim 1, wherein the cutting element comprises a ceramic material.

4. The device of claim 1, wherein the movable member is pivotably connected to said base between the cutting area and the grip area.

5. The device of claim 4, wherein the pivotal connection is provided by at least one hinge connection between said movable member and said base.

6. The device of claim 1, the movable member having a relief to accomodate the cutting element in the closed position.

7. The device of claim 1, wherein the movable member in the open position exposes the cutting element and provides support for a package being cut.

8. The device of claim 1, wherein the device is comprised of plastic, wood, rubber or metal.

9. A package opening device comprising:
a base having a first end, a second end and a cutting element affixed onto a top surface of the base at the first end; and
a movable member pivotably attached to the top surface of the base plate between the first and second end, wherein the movable plate is pivotable with respect to said base plate to expose said cutting element in an open position and to cover said cutting element in a closed position.

10. The device of claim 9, wherein the cutting element comprises a ceramic material.

11. The device of claim 9, wherein the pivotal attachment is provided by at least one hinge connecting said movable member with said base.

12. The device of claim 9, the movable member having a relief adapted to receive the cutting element in the closed position.

13. The device of claim 9, wherein the movable member in the open position exposes the cutting element and provides a guide and/or support for a package being cut.

14. The device of claim 9, wherein a fastening mechanism is provided for maintaining the device in a closed position.

15. The device of claim 9, wherein a stop mechanism is provided for maintaining the device in a desired open position.
